(19) United States
(12) Patent Application Publication
(10) Pub. No.: US 2004/0052068 A1
(43) Pub. Date: Mar. 18, 2004

(54) Helmet having warning device

(76) Inventors: Yuan-Chung Chien, Mienshiueng Hsian (TW); Ta-Chiao Chien, Mienshiueng Hsian (TW)

Correspondence Address: BACON & THOMAS, PLLC, 625 SLATERS LANE, FOURTH FLOOR, ALEXANDRIA, VA, 22314

(21) Appl. No.: 10/245,334

(22) Filed: Sep. 18, 2002

(51) Int. Cl. F21V 21/084

(52) U.S. Cl. 362/105; 2/105; 362/106; 362/107; 362/164; 362/209

(57) ABSTRACT

A helmet having a warning device includes at least one illuminator externally mounted on a helmet body. A solar power supplying device has a solar panel fixedly mounted on a top surface of the helmet body for absorbing solar energy, which can be converted into electrical energy by means of a control circuit board and saved to an accumulator. The accumulator supplies the illuminator with required electricity to generate illumination. The control circuit board can detect if there is any solar energy gathered by the solar panel so as to automatically control the illuminator to generate illumination or not. A switch, when the illuminator automatically generates illumination, can be activated again to forcibly control the illuminator to continually generate illumination or not.

### FIELD OF THE INVENTION

The present invention relates generally to a safety helmet, and more particularly to a helmet having warning device.

### BACKGROUND OF THE INVENTION

While riding motorcycles or bicycles or other vehicles, people should be aware of no speeding, wearing safety helmets, and turning on the vehicle lights in the dusky environment, thus, it's safe for the riders and other people whom can be warned of the jeopardy.

When the riders use the foregoing vehicles in the dusky environment, such as in tunnels or at night, front lamps of motorcycles or additional lamps of bicycles are taken as limited illumination for the riders to get clear frontal view and for other people from the back to get fuzzy view. Although the motorcycle is equipped with rear lamps, the rear lamps' illumination is not bright enough to warn other people from the back of the riders in a distance. As for bicycles, rear reflecting panels, which is the only warning device, mounted behind the frames of the bicycles fail to be diametrically effective in warning.

Accordingly, in addition to original vehicular lamps and reflecting panels, most of practitioners and riders will attach a reflecting sticker 2, as shown in FIG. 1, on a safety helmet 1 by increasing reflective area to have warning effects. However, the reflecting sticker 2 has to be projected by the light in a short distance so as to be reflective, so that it's not the best choice.

### SUMMARY OF THE INVENTION

The primary objective of the present invention is to provide a helmet, which has an illuminator mounted on the helmet to automatically generate illumination in accordance with the brightness of outside environment to have warning effects.

Another objective of the present invention is to provide a helmet, which can be controlled forcibly to maintain illuminating by means of a switch while the illuminator generates illumination.

A further objective of the present invention is to provide a helmet, which absorbs solar energy and converts it into electrical energy supplying the illuminator with required electricity. According to the foregoing objectives of the present invention, the helmet provided by the present invention includes a helmet body having a hard shell and a lining, at least one illuminator mounted on the hard shell of the helmet body, a solar power supplying device mounted on the helmet body and having a solar panel, which is fixedly mounted on the hard shell, to absorb solar energy, a control circuit board for converting the solar energy into the electrical energy, and an accumulator for saving the electrical energy, which supplies the illuminator with required electricity to generate illumination, and a switch. The control circuit board is able to detect if there is any solar energy so as to automatically control the illuminator to generate illumination or not. The switch is electrically connected with the control circuit board and is able to be activated or not to forcibly keep the illuminator generating illumination while the control circuit board controls the illuminator to generate illumination.

### BRIEF DESCRIPTION OF THE DRAWINGS

FIG. 1 is a schematic view of a prior art safety helmet adhesively mounted with reflecting stickers;

FIG. 2 is an exploded perspective view of a preferred embodiment of the present invention;

FIG. 3 is a perspective view of the preferred embodiment of the present invention;

FIG. 4 is a top view of the preferred embodiment of the present invention;

FIG. 5 is a cross-sectional view of the preferred embodiment of the present invention, showing that illuminators don't generate illumination;

FIG. 6 similar to FIG. 5 shows that the illuminators generate illumination;

FIG. 7 is a schematic electrical representation of a circuitry of the preferred embodiment of the present invention;

FIG. 8 is a schematic view of the preferred embodiment of the present invention applied in the dusky environment;

FIG. 9 is a perspective view of another preferred embodiment of the present invention, showing that a switch has a button externally mounted on a hehnet body; and

FIG. 10 is a perspective view of a further preferred embodiment of the present invention, showing that the switch has a switchable keypad externally mounted on a helmet body.

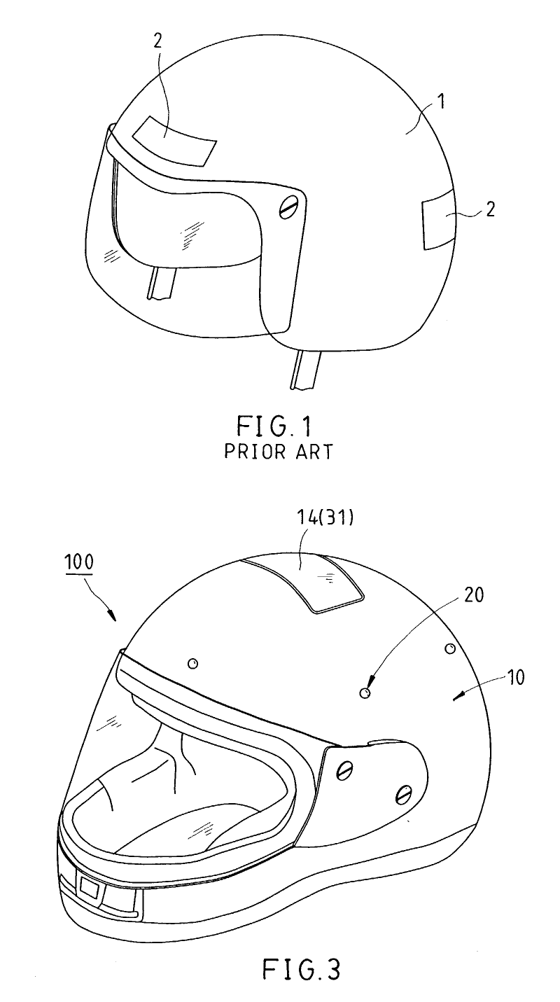

### DETAIL DESCRIPTION OF THE INVENTION

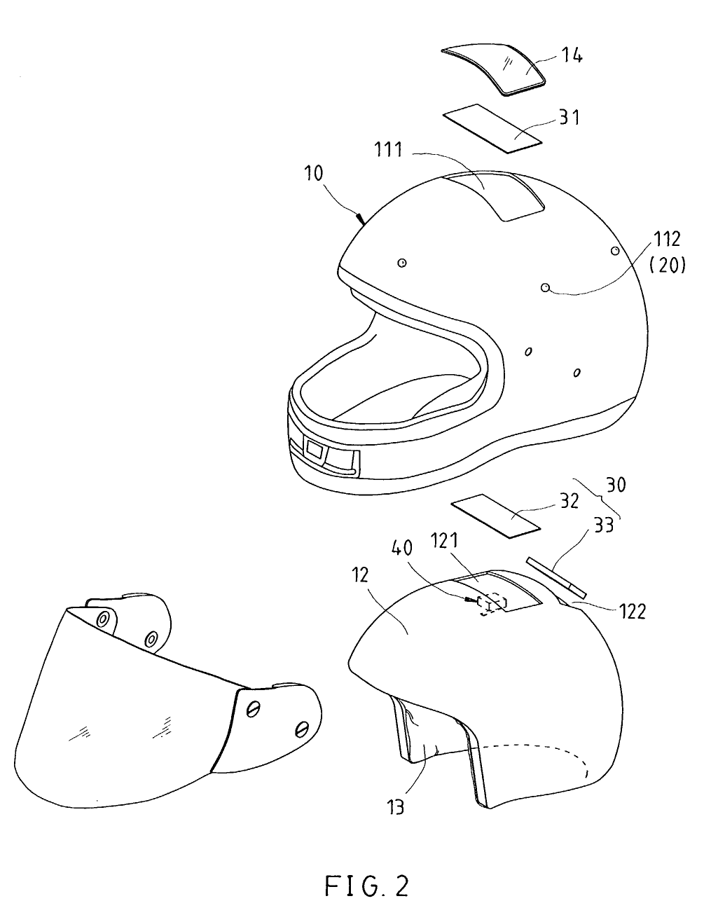

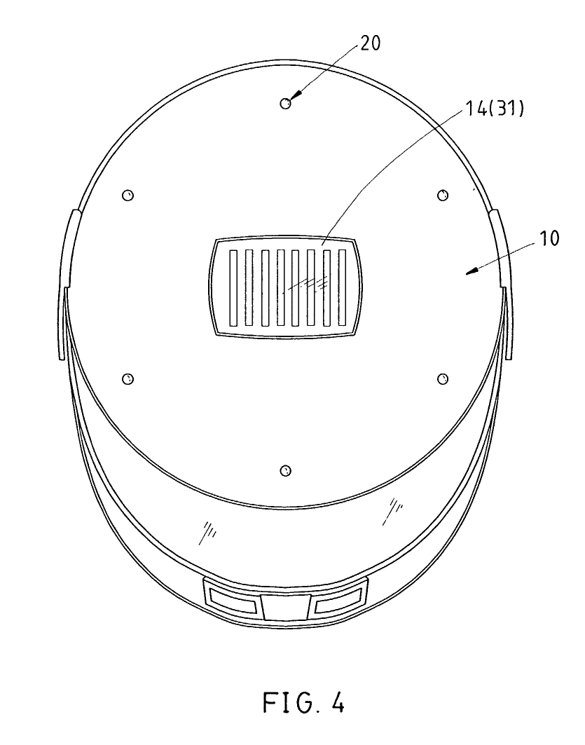

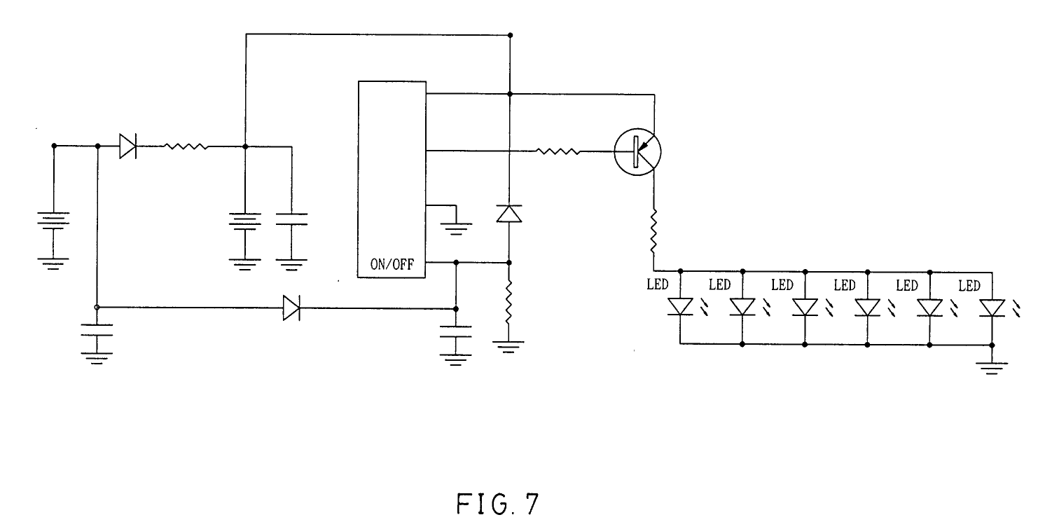

Referring to FIGS. 2-7, a helmet 100, which is a full-masked safety helmet for riding a motorcycle, is composed of a helmet body 10, illuminators 20 made of light emitting diodes (LEDs), a solar power supplying device 30, and a switch 40.

The helmet body 10 has an integrally formed hard shell 11, a pad 12, a lining 13, and a transparent panel 14.

The hard shell 11 has a top surface, which is recessed with a receiving chamber 111 thereon. The hard shell has a plurality of holes 112 around the receiving chamber 111. The transparent panel 14 is covertly disposed on an opening of the receiving chamber 111 and has an approximately arced top surface to be formed with an outer surface of the hard shell 11 as a continuous surface. The transparent panel 14 has a bottom to be spaced apart from a bottom of the receiving chamber 111 such that a space is defined between the transparent panel 14 and the bottom of the receiving chamber 111.

The pad 12, which is made of polystyrene with a predetermined thickness, has a side contacting an inner side of the hard shell and recessed with a first recession 121 and a second recession 122, wherein the first recession 121 is in a position under the receiving chamber 111. The pad 12 further has a third recession 123 recessed on an opposite side corresponding in location to the first recession 121.

The lining 13 is a flexible cloth, which is attached to the curved inner surface of the pad 12, making a user feel comfortable while his or her head touches it. Additionally, the lining 13 has a flexible leather mat corresponding in location to the third recession 123.

The LEDs 20 are respectively received in the holes 112 of the hard shell 11 and have tops extending out of the holes 112 so as to completely emit the illumination, which is generated by the LEDs 20, outside the helmet body 10.

The solar power supplying device includes a solar panel 31, a control circuit board 32, and an accumulator 33.

The solar panel 31 is received in the space between the transparent panel 14 and the receiving chamber 111 and has a side facing upward to absorb solar energy.

The control circuit board 32 is fixedly mounted under the receiving chamber 111 and is received in the first recession 121. The accumulator 33 is received in the second recession 122. Additionally, the control circuit board 32, which is electrically connected with the LEDs 20 and the solar panel 31 and the accumulator 33, can convert the solar energy into the electrical energy and save it to the accumulator 33, which supplies the LEDs 20 with the required electricity for the lamps generating illumination.

Furthermore, the control circuit board 32 can automatically control the LEDs 20 to generate illumination by means of the solar panel 31 detecting if there is any solar energy. Namely, if there is solar energy outside to be absorbed by the solar panel 31, the control circuit board 32 will break circuits OFF, which connect to the LEDs 20, so that the LEDs 20 will not generate illumination and the electrical energy converted from the solar energy is directly saved to the accumulator 33. On the contrary, in the environment of no sunshine, such as in tunnels or in rainy days or at night, the control circuit board 32 keeps the circuits ON such that the LEDs automatically generate illumination.

The switch 40, which is covertly received in the third recession 123, is electrically connected with the control circuit board 32 and can be activated by an external force to forcibly keep the LEDs 20 generating illumination. The operational process is described hereunder.

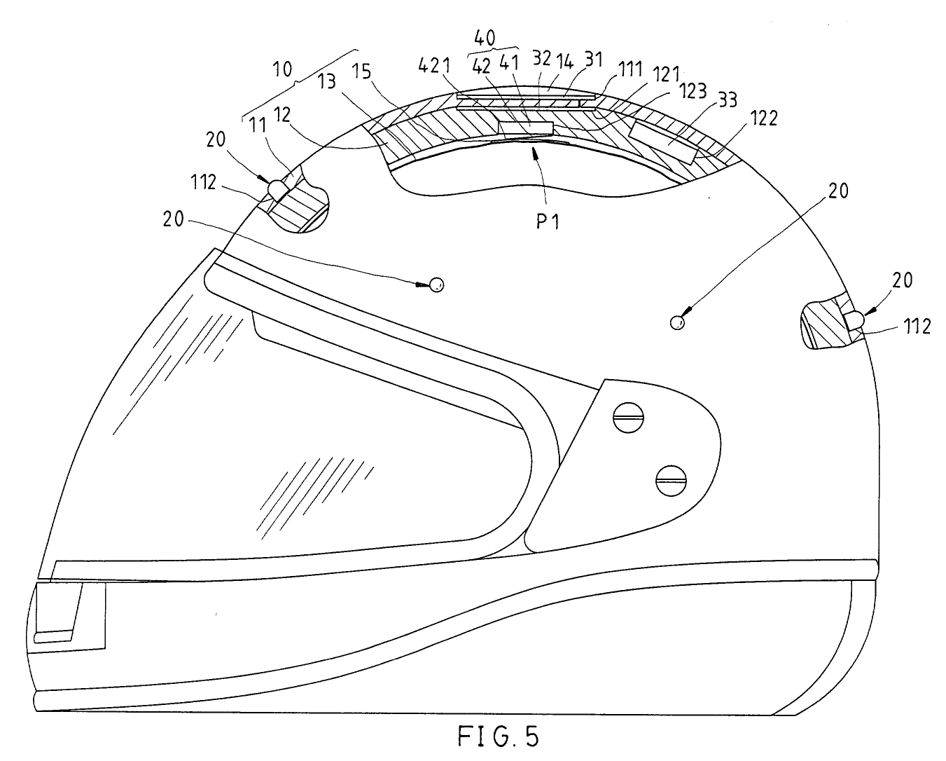

As shown in FIG. 5, the switch 40 includes a controller 41 and an elastic contact piece 42 having an end, which is defined as a touch end 421, to contact against the leather mat 15 and having the other end connecting to the controller 41. In general, when the touch end 421 is not pressed, that is, the safety helmet 100 is not worn by the user, the touch end 421 is located at a first position P1, meanwhile, the controller 41 forcibly breaks the circuits OFF, so that the lamps 20 don't generate illumination. Additionally, the leather mat 15 is taken as a medium between the switch 40 and the user's head such that the user feels soft and comfortable while wearing the safety helmet 100. Alternatively, the leather mat 15 is not necessarily required in the present invention.

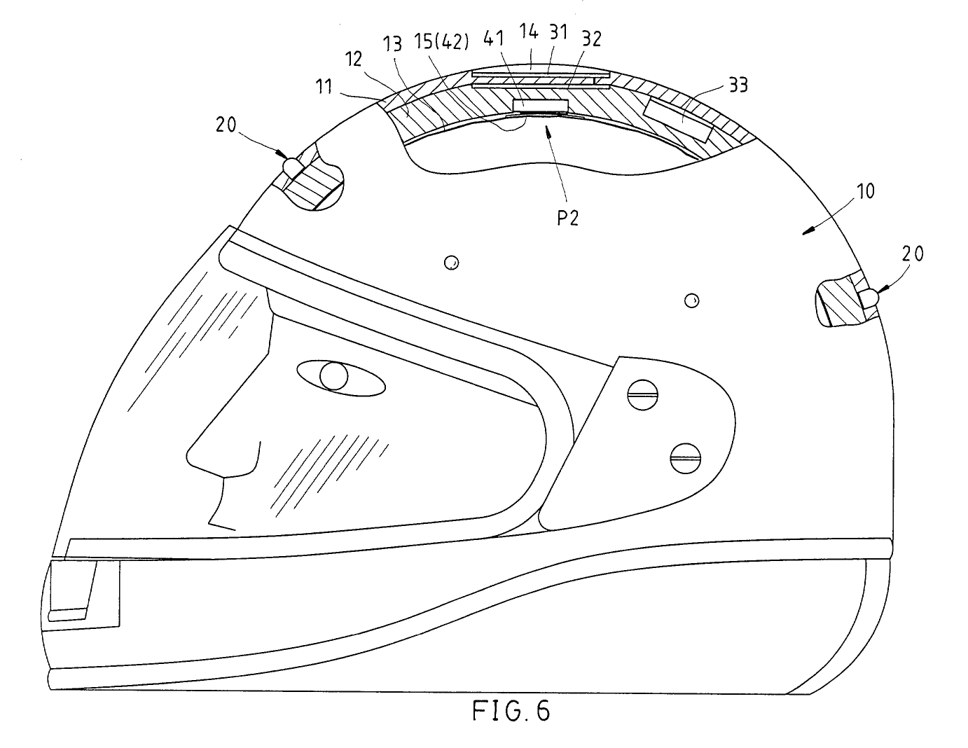

Referring FIG. 6, while the user wears the safety helmet 100, the touch end 421 is indirectly pushed so as to be shifted from the first position P1 to a second position P2. In the meantime, the controller 41 is activated to keep the circuits ON, so that lamps 20 can generate illumination.

The operational process of controlling the LEDs 20 of the present invention is described hereunder:

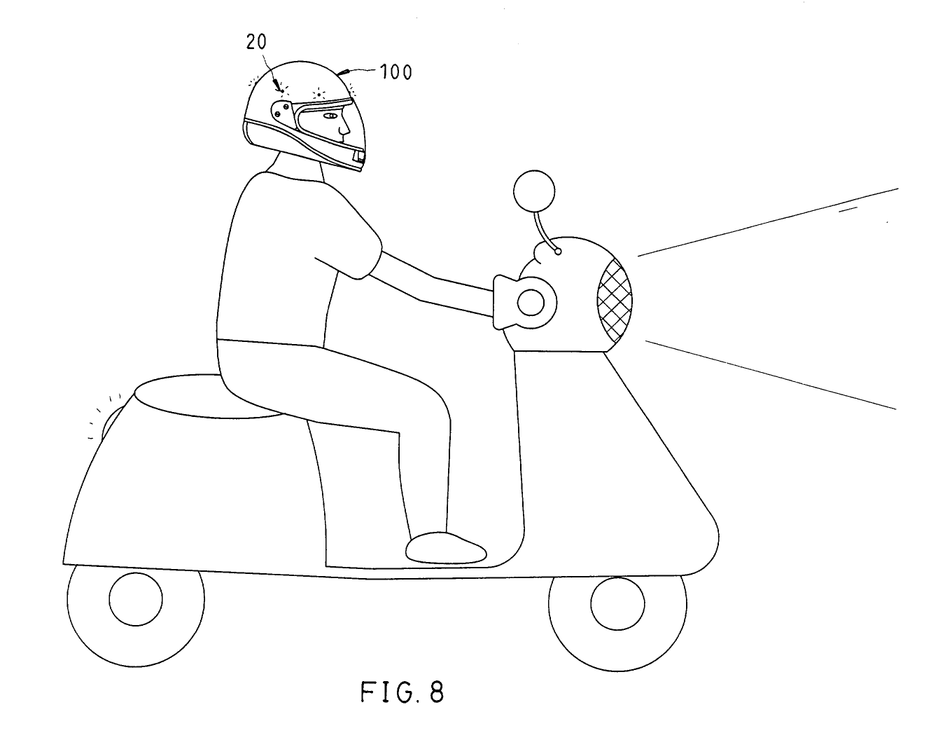

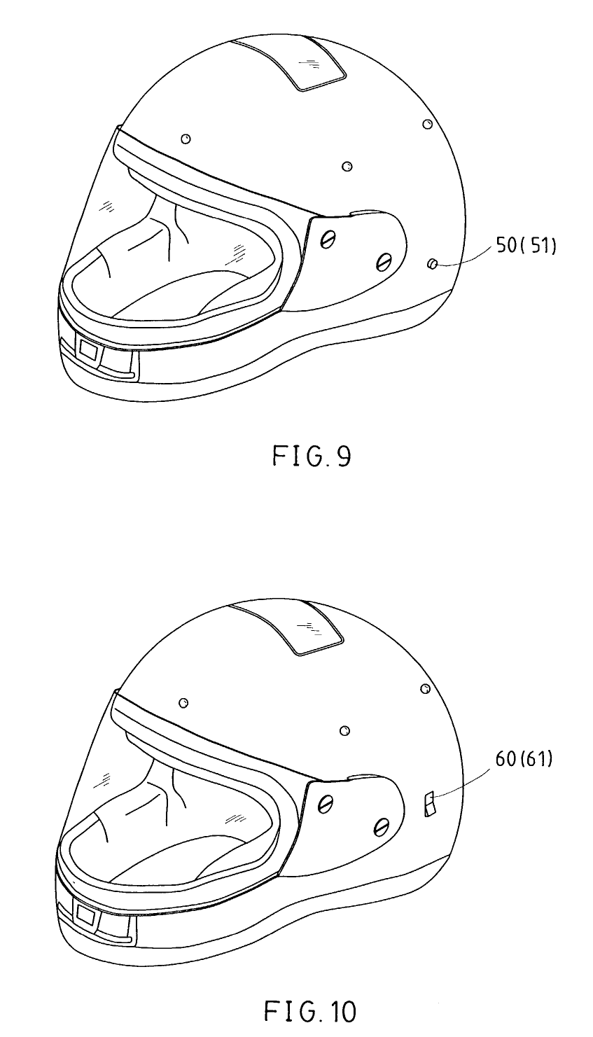

Firstly, when the user rides a motorcycle with the safety helmet 100 on his or her head in the outdoor sunshining environment, the solar energy is absorbed by the solar panel 31 and converted into the electrical energy by the control circuit board 32 and then saved to the accumulator 33, which keeps charging. Under this condition, the control circuit board 32 synchronically controls the LEDs 20 not to generate illumination to prevent the electricity of the accumulator 33 from losing. Moreover, though the touch end 421 of the switch 40 remains being pushed to the second position P2, referring FIG. 6, the switch 40 functions only when the LEDs 20 generate illumination. In the dusky environment of inside tunnels or rainy days or night, when the accumulator 33 still has the electricity and the touch end 421 of the switch 40 remains at the second position P2, the control circuit board 32 keeps the circuits ON so as to actuate the lamps 20 to generate illumination, which brightness is high enough to draw other people's attention, as shown in FIG. 8. Alternatively, the LEDs 20 can generate blinking or flashing illumination.

Secondly, when the user enters a room with the safety helmet 100 on his or her head and the LEDs 20 still automatically generate illumination, and then the user takes off the safety helmet 100, the touch end 421 of the switch 40 is not pushed by the user's head so as to return to the first position P1, so that the controller 41 forcibly breaks the circuits OFF. Accordingly, the LEDs 20 do not generate illumination anymore and the accumulator 33 does not ever consume the electricity as well.

Therefore, the present invention can convert the solar energy into the electrical energy and take charging and save the electrical energy, meanwhile, the LEDs 20 under control of the circuit board 32 don't generate illumination. But when in the dusky environment, the control circuit board 32 controls the LEDs 20 to automatically generate illumination to warn other people. Likewise, when the user takes off the safety helmet 20 in the dusky environment, the switch 40 can forcibly control the LEDs 20 to stop generating illumination to avoid losing the electricity.

Additionally, when the user parks his or her motorcycle in the outdoor sunshining environment without sunshade, the safety helmet 100 of the present invention can be hung on a rear mirror of the motorcycle and a frame of the rear mirror keeps pushing the touch end 421 to stay at the second position P2, so that the solar panel 31 can continually absorb the solar energy and the accumulator 33 can keep charging as well.

Referring to another preferred embodiment of the present invention in FIG. 9, the difference between the foregoing embodiment and the present embodiment lies in that the switch 50 has a button 51 externally mounted on the hard shell 11, wherein the button 51 can be pressed to forcibly break the circuits and to deactivate the LEDs 20 not to generate illumination anymore under condition of the LEDs 20 automatically illuminating.

Referring to a fuirther preferred embodiment of the present invention as shown in FIG. 9, the difference between the foregoing embodiments and the present embodiment lies in that the switch 60 has a switchable keypad 61 externally mounted on the hard shell 11, wherein the switchable keypad 61 can be pressed to forcibly break the circuits and to deactivate the LEDs 20 not to generate illumination anymore under condition of the LEDs 20 automatically illuminating.

In addition, the illuminator of the present invention can be constructed by a transparent tube and an LED lamp or LED. The transparent tube is mounted on the periphery of the hard shell 11 of the safety helmet 100 and has an end approaching the LED lamp or the LED. Accordingly, when the LED lamp or the LED generates illumination, the transparent tube looks like a beam of light around the helmet 100 and it works like the LEDs 20 of the foregoing embodiment of the present invention.

What is claimed is:

1. A helmet comprising:
a helmet body having a hard shell and a lining;
at least one illuminator mounted on said hard shell of said helmet body;
a solar power supplying device mounted on said helmet body and including a solar panel for gathering solar energy, a control circuit board for converting the solar energy into electrical energy, an accumulator for saving the electrical energy and supplying said illuminator with required electricity to generate illumination, said control circuit board being capable of detecting if there is any solar energy gathered by the solar panel and automatically control said illuminator to generate illumination or not, and
a switch electrically connected with said control circuit board and being able to be activated or deactivated to forcibly control said illuminator to continually generate illumination or not.

2. The helmet as defined in claim 1, wherein said helmet body further includes a pad between said hard shell and said lining, said pad having at least a recession for receiving said control circuit board and said accumulator, which are covertly disposed between said hard shell and said lining.

3. The helmet as defined in claim 2, wherein said switch is covertly disposed between said hard shell and said lining and includes a controller electrically connected with said control circuit board and a contact piece switched between a first position, where said controller breaks circuits not to connect to said illuminator, and a second position, where said controller keeps the circuits connecting to said illuminator.

4. The helmet as defined in claim 3, wherein said contact piece of said switch is a recoverable elastic piece including an end, defined as a touch end, shifted between the first position and the second position while said helmet body is worn and taken off, and the other end connecting to said controller, which fimctions with movement of said touch end.

5. The helmet as defined in claim 2, wherein said switch is externally mounted on said hard shell and includes a button pressed to forcibly control said illuminator to generate illumination or not while said control circuit board controls said illuminator to generate illumination.

6. The helmet as defined in claim 2, wherein said switch is externally mounted on said hard shell and includes a switchable keypad pressed to forcibly control said illuminator to generate illumination or not while said control circuit board controls said illuminator to generate illumination.

7. The helmet as defined in claim 1, wherein there are numbers of said illuminators mounted on the periphery of said hard shell, said illuminator is made of LED.
